(19) United States
(12) Patent Application Publication
(10) Pub. No.: US 2008/0073499 A1
(43) Pub. Date: Mar. 27, 2008

(54) Peak finding in low-resolution mass spectrometry by use of chromatographic integration routines

(76) Inventors: George Yefchak, Santa Clara, CA (US); James H. Crabtree, Long Beach, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/492,368

(22) Filed: Jul. 25, 2006

(51) Int. Cl. B01D 59/44

(52) U.S. Cl. 250/282

(57) ABSTRACT

Methods for processing low resolution mass spectrometry data, including providing the low resolution mass spectrometry data as abundance versus flight time data, converting the flight time axis of the low resolution mass spectrometry data to a calibrated mass axis, and converting that to retention time-based chromatographic data. The time-based data may then be converted back to abundance versus mass data and processed to create a mass spectrum.

### FIELD OF THE INVENTION

The present invention provides methods for analyzing spectra from low resolution mass spectrometry (LRMS) by applying algorithms utilized for the identification and characterization of peaks generated by gas or liquid chromatography.

### BACKGROUND OF THE INVENTION

Mass spectrometry systems are analytical systems used for quantitative and qualitative determination of the compositions of materials, which include chemical mixtures and biological samples. In general, a mass spectrometry system uses an ion source to produce electrically charged particles (e.g., molecular or polyatomic ions) from the material to be analyzed. Once produced, in the source of a high resolution mass spectrometer, the electrically charged particles are introduced to the mass spectrometer and separated by a mass analyzer based on their respective mass-to-charge ratios. The abundance of the separated electrically charged particles are then detected and a mass spectrum of the material is produced. The mass spectrum provides information about the mass-to-charge ratio of a particular compound in a mixture sample and, in some cases, information about the molecular structure of that component in the mixture.

Other mass spectrometers such as a linear time-of-flight instrument, measures the flight time of the ions across a fixed length path. Linear time of flight (TOF) mass spectrometers have the benefits of being relatively inexpensive, fast scanning and have an extremely high mass range (e.g. greater than 1 million Daltons). Resolution in TOF mass spectrometers is related to path length, and hence to instrument size. Though large TOF instruments can achieve very good mass resolution and mass accuracy, smaller (e.g., 10-cm path) instruments may be attractive for reasons of cost, weight, portability, operating pressure, etc. Such miniature TOF instruments typically yield very low mass resolution.

In general, the major disadvantage of LRMS instruments, such as a miniature TOF instrument, is the very low or low resolution MS spectra generated. However, even when mass resolution falls below the commonly desired “unit mass resolution” level, as seen with LRMS, the spectra can still contain information highly indicative of the sample's composition and abundance.

Because low-resolution spectra obtained with LRMS can be regarded as a set of bunched single-amu spectral lines, useful mass spectral libraries can definitely be constructed from a group of single-compound spectra taken via LRMS.

Many well established methods exist for “peak finding”, the identification and characterization of signals from an individual mass-to-charge (m/z) ratio, in mass spectrometry. These generally make use of the fact that mass resolution is sufficient to provide unambiguous differentiation between adjacent mass values. Peak-finding algorithms identify each peak's mass and intensity, and thus produce a list of pairs of corresponding masses and intensities commonly referred to as mass-intensity pairs. Peak-finding algorithms used for unit-mass-resolution (or higher) mass spectra are not appropriate for “very low resolution” spectra, thus there is a need for methods of analyzing these signals.

The techniques described herein may be used with any type of mass spectrometer capable of producing low or very low resolution mass spectra and any description to a particular type of mass spectrometer should not be construed so as to limit the application of the techniques described herein.

### SUMMARY OF THE INVENTION

The methods of the invention comprise, in general terms, providing low resolution mass spectrometry, converting the flight time axis of the low resolution mass spectrometry data to retention time-based axis to enable the low resolution mass spectrometry data to be represented as abundance versus retention time chromatographic data, and processing the chromatographic abundance versus retention time data to determine peak retention times and peak areas of the chromatogram.

In at least one embodiment, the low resolution mass spectrometry data is provided as abundance versus flight time data

The methods may further comprise converting the retention time-based chromatographic data back to flight time (mass)-based low resolution mass spectrometry data.

The methods may further comprise processing the flight time based low resolution mass spectrometry data to create a mass spectrum.

In certain embodiments the converting or treating the flight time axis of the low resolution mass spectrometry data as a retention time axis may comprise converting mass units to time units.

In certain embodiments the converting the flight time axis of the low resolution mass spectrometry data to a retention time axis may comprise shifting numeric mass values by a selected amount such that the numeric range of the retention time axis resembles a GC or LC elution time frame profile.

In certain embodiments the processing of the retention time-based chromatographic data may comprise digital smoothing of the abundance data as a function of time prior to further processing.

In certain embodiments the processing of the retention time-based chromatographic data may comprise defining an initial base line for the retention time axis.

In certain embodiments the processing of the retention time-based chromatographic data may further comprise tracking and updating the baseline.

In certain embodiments the processing of the retention time-based chromatographic data may further comprise identifying peak widths.

In certain embodiments the processing of the retention time-based chromatographic data may further comprise applying one or more recognition filters to the retention time-based chromatographic data.

In certain embodiments the processing of the retention time-based chromatographic data may further comprise applying a bunching algorithm to the retention time-based chromatographic data.

In certain embodiments the processing of the retention time-based chromatographic data may further comprise applying a peak recognition algorithm to the retention time-based chromatographic data.

In certain embodiments the processing of the retention time-based chromatographic data may further comprise applying a peak apex algorithm to the retention time-based chromatographic data.

These and other advantages and features of the invention will become apparent to those persons skilled in the art upon reading the details of the methods for LRMS analysis as more fully described below.

### BRIEF DESCRIPTION OF THE DRAWINGS

FIG. 1 is an illustration of a very low resolution mass spectrum of xenon obtained with a miniature time-of-flight mass analyzer.

FIG. 2 is a flow chart of one embodiment of the method of analyzing LRMS spectra in accordance of the invention.

FIG. 3 is a flow chart of one embodiment of the method for peak recognition of a LRMS spectra.

FIG. 4 is an illustration of the results of the analysis of the converted, low-resolution, uTOF data shown in FIG. 1 accordance to the methods and processes of the invention.

### DETAILED DESCRIPTION OF THE INVENTION

Before the present methods are described, it is to be understood that this invention is not limited to particular LRMS spectra described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a curve analysis” includes a plurality of such analyses and reference to “the peak” includes reference to one or more peaks and equivalents thereof known to those skilled in the art, and so forth. Similarly, “spectrum” and “spectra” may be used interchangeably and should be understood as meaning either a singular “spectrum” or plural “spectra”.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

For mass spectrometry, many well established methods exist for “peak finding”, which means the identification and characterization of signals from an individual mass-to-charge (m/z) ratio. These methods generally make use of the fact that mass resolution is sufficient to provide unambiguous differentiation between adjacent mass values as normally found in high resolution mass spectrometry. Unfortunately, these methods are not very useful when analyzing low resolution mass spectrometry spectra where the mass peaks of adjacent mass values overlap one another or are bunched together.

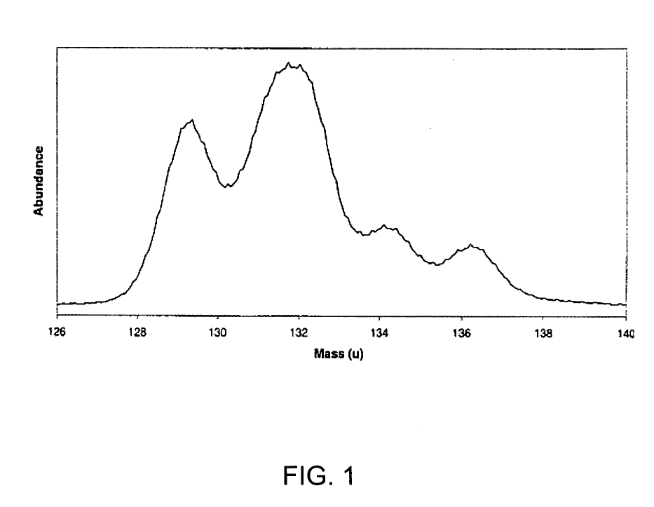

FIG. 1 is a graphical illustration of a low-resolution mass spectrum of xenon obtained by a miniature TOF mass analyzer. The spectrum is shown as abundance or intensity of mass vs. mass (u). This low resolution mass spectrum is representative of LRMS spectra which usually have no baseline separation between peaks of abundance (or intensity), partly due to overlapping mass values, complicating “peak finding” spectral analysis using basic mass spectrometry methods.

The invention provides methods to process spectra from a low-resolution mass sensor (i.e. LRMS spectra) by treating the LRMS spectra as a gas or liquid chromatography profile and applying integration/peak recognition routines normally utilized to identify and characterize peaks in gas (GC) or liquid (LC) chromatography spectra.

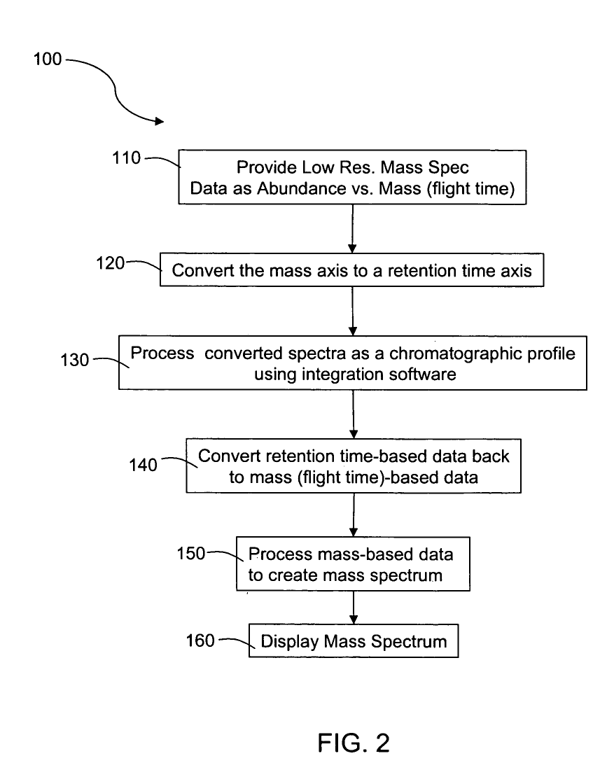

Referring to FIG. 2, there is shown a flow chart illustrating one embodiment of a method for processing LRMS spectra in accordance with the invention. The method of analyzing a LRMS spectra 100 initially comprises providing at least one LRMS data set represented as an abundance vs. mass (flight time) spectrum, in event 110. In many embodiments, one or more time-of-flight mass spectra are obtained using miniature TOF MS, thus a plurality of LRMS data sets of a sample of interest may be taken and averaged to achieve a more accurate LRMS spectrum of the sample to be analyzed.

Converting the flight time (mass) axis of the LRMS spectra into a chromatographic retention time axis may involve a linear, square root, or polynomial conversion of flight time to time in minutes, seconds, milliseconds, or other time units or fractions thereof. For example a flight time of 200 would be converted to a retention time of 200 milliseconds, two hundred seconds, or other suitable time value depending on the peak recognition software to be utilized in the analysis of the spectra. In the case of the miniature TOF the flight time is to be converted to calibrated mass via the square root relationship and other algorithms and that in turn is converted into chromatographic retention time. In other embodiments, treating the calibrated mass values on the mass axis as chromatographic retention time values may involve shifting the numeric mass values by a specified amount to allow the numeric range of the converted mass axis to resemble a more typical elution time frame found in GC or LC chromatographic profiles.

Once the LRMS spectra has been converted into an abundance vs. retention time profile in event 120, the method shown in the flow chart of FIG. 2, further comprises applying algorithms to the retention time-based converted spectra to identify and characterize peaks and their positions within the converted spectra, in event 130. The converted spectra are treated as a gas (GC) or liquid (LC) chromatographic peaks and may be processed as such by traditional GC or LC chromatography analysis techniques. Many software systems for processing of GC or LC chromatography data are commercially available and may be used in event 130.

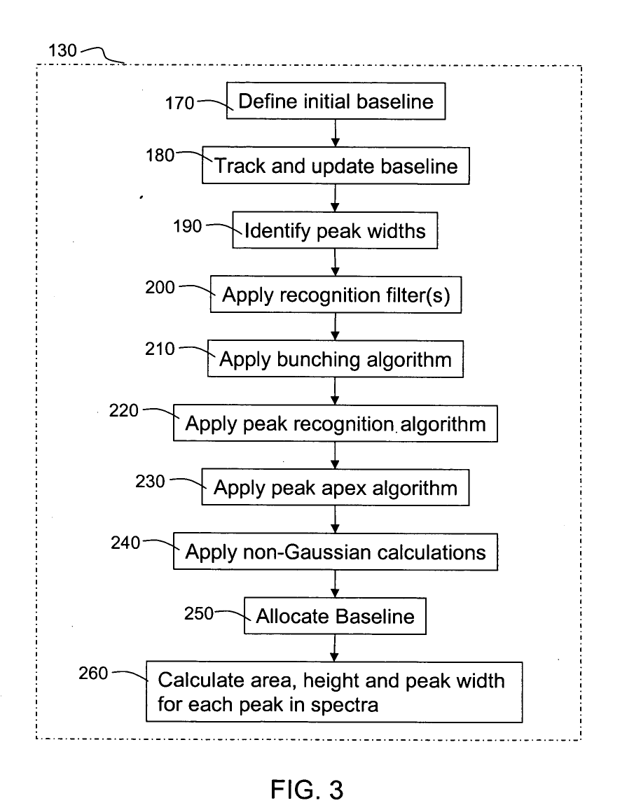

In many embodiments the chromatographic analysis software used in event 130 defines an initial baseline, tracks the baseline, and then identifies the time in which a peak begins and ends. The software may also provide for determining the apex, peak height and peak area of each peak in the converted spectra and their corresponding position, e.g. retention time. One embodiment of the integration routines and peak recognition involved in event 130 is shown in FIG. 3 and described further below. In many embodiments the processing of the converted spectra from event 120 by chromatographic software in event 130 involves applying a variety of peak detection algorithms and routines traditionally utilized in analyzing LC or GC chromatographs not specifically mentioned within this specification. Numerous peak detection methods, including use of various peak maxima and minima location techniques; first, second and higher-order derivatives of the converted signal; peak deconvolution techniques; noise reduction techniques; baseline identification techniques and other techniques are well known to those skilled in the art and may be used with the invention. Thus, it should be understood that the details of FIG. 3 below should be considered as merely exemplary and not limiting.

In event 140, the retention time-based data of event 130 is converted back to mass (flight time)-based data. In one embodiment, this event is carried out by directly encoding the data of event 130 as mass, intensity pairs. In another embodiment, the time axis of the data of event 130 may be converted back to a mass axis. Numerous software capable of carrying out these operations are commercially available and are known to persons skilled in the art.

After the time based data from event 130 has been converted back to mass-based data in event 140, the mass-based data is processed to create a mass spectrum in event 150, for example, plotting the data with axes labeled “mass” and “intensity”. When the mass-based data is in the form of a mass, intensity pair peak list, processing the mass, intensity pair peak list may be carried out with conventional mass spectral analysis software such as Agilent's MSD CHEMSTATION™. The results may then be displayed, in event 160, in a conventional mass spectrometry format such as abundance (intensity) vs. mass (u).

Referring now to FIG. 3, there is shown a flow chart of one embodiment of the processing the converted LRMS spectra as a chromatographic (retention time-based) profile. The processing of the converted LRMS spectra comprises defining an initial baseline for the converted, retention time-based spectra in event 170. An initial baseline level for the retention time axis is established by taking a first data point as a tentative baseline point. This initial baseline point may be redefined based on the average of the input signal. If a redefined initial baseline point is not obtained, the first data point may be retained as a potential initial baseline point.

The converted, retention time-based LRMS spectrum data is further analyzed in event 180 by continuously tracking the baseline during a peak identification process. Integration is carried out using a baseline-tracking algorithm which determines the slope of the signal by the first derivative and the curvature by the second derivate. The initial baseline point, established at the start of the analysis, is continuously reset at a predetermined rate and the integration tracks and periodically updates the baseline to compensate for such spectral attributes as drift, until a peak up-slope is detected.

The method further comprises, in event 190, identifying the peak widths, which may be calculated from the peak areas and the peak heights and other chromatographic moments. In some embodiments, when inflection points are available, the peak width may be determined by the width or separation between the inflections points. The identification of peak width controls the ability to distinguish peaks from baseline noise.

In many embodiments, including the embodiment described in FIG. 3, at least one recognition filter (event 200) is applied to the retention time-based converted LRMS spectrum data to recognize peaks by detecting changes in the slope and curvature within a set of contiguous data points. In general, the recognition filters contain the first derivative (to measure slope) and/or the second derivative to measure curvature of the data points being examined by the integrator routine. The actual filtering utilized in the application may be determined by the peak width setting which may be updated as necessary to optimize integration.

The method further comprises applying a bunching algorithm to the data points of the converted spectra in event 210. “Bunching” involves clustering data points within the effective range of the peak recognition filters to maintain good peak selectivity. The software integrator routine cannot continue to indefinitely increase peak width for broadening peaks, since the peaks would become so broad that they could not be seen by the peak recognition filters. To overcome this limitation, the bunching algorithm is used to bunch the data points together, effectively narrowing the peaks while maintaining the same peak area. Bunching of data points is based on such factors as data rate and peak width, and the integrator uses these parameters to set a “bunching factor” to give the appropriate number of data points for an expected peak width.

The embodiment of FIG. 3 further comprises applying peak recognition algorithm (event 220), followed by applying a peak apex algorithm (event 230) to the data points of the converted LRMS spectra. The peak recognition algorithm of event 220 identifies the start of a peak using the initial slope sensitivity, to increase or decrease an up-slope accumulator. When it is determined that the point at which the value of the up-slope accumulator is greater than or equal to a predetermined value, the peak recognition algorithm indicates that a peak is beginning along the time axis. Similarly, when the integrator determines the point at which the value of a down-slope accumulator is greater than or equal to a predetermined value, the peak recognition algorithm recognized that the peak is ending along the retention time axis.

Once a peak is detected or recognized in event 220, the peak apex is located or recognized in event 230, by the peak apex algorithm, as the highest point (or highest local point) in the chromatogram by constructing a parabolic fit that passes through the highest data points as determined by the peak apex algorithm 230. Also, in many embodiments of the methods of the invention, the GC or LC chromatographic software used to analyze the converted LRMS spectra, further comprises, using non-Gaussian calculations 240 to further recognize and separate merged peaks within the converted spectra.

Allocation of the baseline in event 250 may be carried out continuously, intermittently or at certain specified times throughout the analysis of the converted spectra. The tracking of the baseline occurs early on in the processing of the chromatogram, allowing baseline allocation of merged peaks or peak clusters. After a peak cluster has been detected, and the baseline is found, the integrator requests a baseline allocation algorithm to allocate the baseline using a pegs-and thread technique to identify individual peaks within a peak cluster. The baseline allocation algorithm may use trapezoidal area and proportional height corrections to normalize and maintain the lowest possible baseline within the peak cluster region.

Additional processing may be used on the converted LRMS spectra, including but are not limited to, baseline penetration, advanced baseline tracking utilizing peak valley ratios, deconvolution by calculating centroids for recognized peaks, shoulder detection and tangent skimming to construct a baseline for peaks found on the upslope or downslope of a peak or peak cluster.

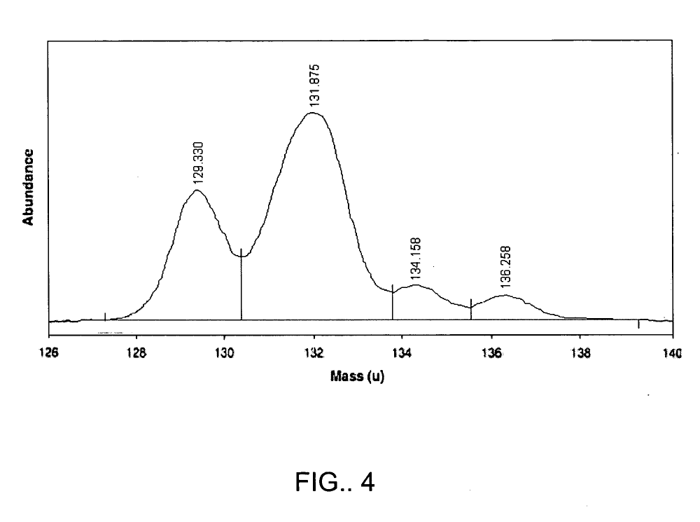

The process of FIG. 3 described above allows for the converted LRMS spectra to be analyzed as if it were a GC or LC chromatographic data, resulting in the calculation of peak area, height and peak width (event 260) for peaks which could not otherwise be identified or characterized in a LRMS spectrum using traditional MS analysis techniques. The process of FIG. 3 may be carried out using various commercial software systems for analysis of GC or LC data. An exemplary software system that may be used with the invention is provided by Agilent's GC CHEMSTATION™. FIG. 4 is a graph of abundance vs. mass which illustrates the results of the methods utilized for the analysis of the converted, low-resolution, uTOF data shown in FIG. 1 via the embodiments of the invention described in FIGS. 3 and 4. A graph of this type, and/or numerical calculated results from any of the steps described above may be outputted to a user via a user interface, such as a computer display or via a printer, or other known output apparatus.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method for processing low resolution mass spectrometry data, the method comprising:
(a) providing the low resolution mass spectrometry data;
(b) converting the flight time axis of the low resolution mass spectrometry data to a retention time-based axis to enable the low resolution mass spectrometry data to be represented as abundance versus retention time chromatographic data; and
(c) processing the chromatographic abundance versus retention time data to determine peak retention times and peak areas.

2. The method of claim 1, further comprising converting the retention time-based chromatographic data back to flight time-based low resolution mass spectrometry data.

3. The method of claim 2, further comprising processing the flight time-based low resolution mass spectrometry data to create a mass spectrum.

4. The method of claim 1, wherein the converting the flight time axis of the low resolution mass spectrometry data to a retention time axis comprises converting mass units to time units.

5. The method of claim 1, wherein the converting of the flight time axis of the low resolution mass spectrometry data to a retention time axis comprises shifting numeric mass values by a selected amount such that the numeric range of the time axis resembles a GC or LC elution time frame profile.

6. The method of claim 1, wherein the processing of the retention time-based chromatographic data comprises defining an initial base line for the retention time axis.

7. The method of claim 6, wherein the processing of the retention time-based chromatographic data further comprises tracking and updating the baseline.

8. The method of claim 7, wherein the processing of the retention time-based chromatographic data further comprises identifying peak widths.

9. The method of claim 8, wherein the processing of the retention time-based chromatographic data further comprises applying at least one recognition filter to the retention time-based chromatographic data.

10. The method of claim 9, wherein the processing of the retention time-based chromatographic data further comprises applying a bunching algorithm to the retention time-based chromatographic data.

11. The method of claim 10, wherein the processing of the retention time-based chromatographic data further comprises applying a peak recognition algorithm to the retention time-based chromatographic data.

12. The method of claim 11, wherein the processing of the retention time-based chromatographic data further comprises applying a peak apex algorithm to the retention time-based chromatographic data.

13. The method of claim 1, wherein the low resolution mass spectrometry data is provided as abundance versus flight time data in step (a).
